(19) United States
(12) Patent Application Publication
(10) Pub. No.: US 2023/0273022 A1
(43) Pub. Date: Aug. 31, 2023

(54) SURVEYING DEVICE AND SURVEYING METHOD

(71) Applicant: NIPPON TELEGRAPH AND TELEPHONE CORPORATION, Tokyo (JP)

(72) Inventors: Yusuke YOSHIMURA, Tokyo (JP); Koji ITASAKA, Tokyo (JP); Kenji HIYOSHI, Tokyo (JP); Daisaku NISHIYAMA, Tokyo (JP); Akira ITO, Tokyo (JP)

(73) Assignee: NIPPON TELEGRAPH AND TELEPHONE CORPORATION, Tokyo (JP)

(21) Appl. No.: 17/928,892

(22) PCT Filed: Jun. 5, 2020
(86) PCT No.: PCT/JP2020/022385

§ 371 Date: Nov. 30, 2022

(51) Int. Cl. G01C 15/02

(52) U.S. Cl. CPC G01C 15/02

(57) ABSTRACT

A measurement device (100) that measures an absolute coordinate of a target object (300) provided inside an excavation ditch (200) includes: a coordinate measurement unit (10) that measures a position coordinate of a reference point in a vertical direction from the target object (300); a distance measurement unit (20) that measures the vertical distance from the reference point to the target object; and a calculation unit (30) that calculates the absolute coordinate of the target object based on the vertical distance and the position coordinate.

### TECHNICAL FIELD

The present invention relates to measurement devices and measurement methods.

### BACKGROUND ART

It is required to accurately determine the positions where road facilities, river facilities, port facilities, underground buried objects (for example, water supply and sewerage), and the like are located and to efficiently perform maintenance of those facilities (for example, see Non-Patent Literature 1). For measuring the coordinates of those facilities, horizontal setting of measurement equipment is specified (for example, see Non-Patent Literature 2).

Operators have performed maintenance work of underground pipelines by knowing the routes of underground pipelines based on road alignments and the distance to underground pipelines. However, in the method in which the positions of underground pipelines relative to road alignments are measured, in the case in which a road alignment is changed, it is difficult for the operator to know the route of the underground pipeline. Hence, nowadays, the operator knows the routes of underground pipelines based on the absolute coordinates of underground pipelines and performs maintenance work for underground pipelines efficiently. A method in which the absolute coordinates of underground pipelines are measured by using global navigation satellite systems (GNSSs) enables the operator to accurately know the routes of underground pipelines even in the case in which road alignments are changed. For example, an operator holding equipment goes into an excavation ditch (see FIG. 8), sets up equipment such as a GNSS receiver, and obtains the absolute coordinates of the underground pipeline.

In recent years, as a method to solve the problem that an operator needs to go into an excavation ditch with equipment, a method is being developed which makes it possible to measure the absolute coordinates of target objects (for example, underground pipelines) without an operator going into an excavation ditch, by combining a stereo camera and a GNSS measurement device including a GNSS antenna, an antenna base, a GNSS module, a GNSS controller, wiring cables, and a tripod (with a level).

### CITATION LIST

### Non-Patent Literature

Non-Patent Literature 1: “Ko-seido Ichijyoho Sokui Douro-ijikanri-bunya eno Tekiyo ni tsuite (Application of Highly Accurate Position Information Positioning to Road Maintenance Field)”, Kensetsu Denki Gijyutsu, Vol. 156, January, 2007
Non-Patent Literature 2: “Total Station niyoru Dekigata Kanri-gijyutu no Tebiki (Guides to Management Techniques for Built Shapes by using Total Station)”, Ministry of Land, Infrastructure, Transport and Tourism, [online], [retrieved on Jun. 7, 2019], the Internet <https://www.kkr.mlit.go.jp/kingi/ict/h2603-02.pdf>

### SUMMARY OF THE INVENTION

### Technical Problem

However, the method in which a GNSS measurement device and a stereo camera are combined has a problem of low efficiency because although the work is efficient if measurement targets are within the image capturing range of the stereo camera, if the excavation ditch is long or curved, it requires measuring several times.

An object of the present invention that has been made in light of the above situation is to provide a measurement device and a measurement method that make it possible to efficiently measure the absolute coordinates of a target object provided inside an excavation ditch.

### Means for Solving the Problem

A measurement device according to an embodiment is a measurement device that measures an absolute coordinate of a target object provided inside an excavation ditch, characterized in that the measurement device includes: a coordinate measurement unit that measures a position coordinate of a reference point in a vertical direction from the target object; a distance measurement unit that measures the vertical distance from the reference point to the target object; and a calculation unit that calculates the absolute coordinate of the target object based on the vertical distance and the position coordinate.

A measurement method according to an embodiment is a measurement method of measuring an absolute coordinate of a target object provided inside an excavation ditch, characterized in that the measurement method includes the steps of: measuring a position coordinate of a reference point in a vertical direction from the target object; measuring the vertical distance from the reference point to the target object; and calculating the absolute coordinate of the target object based on the vertical distance and the position coordinate.

### Effects of the Invention

With the present invention, it is possible to provide a measurement device and a measurement method that make it possible to efficiently measure the absolute coordinates of a target object provided inside an excavation ditch.

### BRIEF DESCRIPTION OF DRAWINGS

FIG. 1 is a diagram illustrating an example of the configuration of a measurement device according to a first embodiment.

FIG. 2 is a diagram illustrating an example of the configuration of a distance measurement unit in the measurement device according to the first embodiment.

FIG. 3A is a diagram illustrating an example of the configuration of a connection mechanism in the measurement device according to the first embodiment.

FIG. 3B is a diagram illustrating an example of the configuration of a connection mechanism in the measurement device according to the first embodiment.

FIG. 4A is a diagram illustrating an example of the configuration of a connection mechanism in the measurement device according to the first embodiment.

FIG. 4B is a diagram illustrating an example of the configuration of a connection mechanism in the measurement device according to the first embodiment.

FIG. 5 is a flowchart illustrating an example of a measurement method according to the first embodiment.

FIG. 6 is a diagram illustrating an example of the configuration of a measurement device according to a second embodiment.

FIG. 7A is a diagram illustrating an example of the configuration of a distance measurement unit in the measurement device according to the second embodiment.

FIG. 7B is a diagram illustrating an example of the configuration of a distance measurement unit in the measurement device according to the second embodiment.

FIG. 8 is a diagram for explaining an example of excavation.

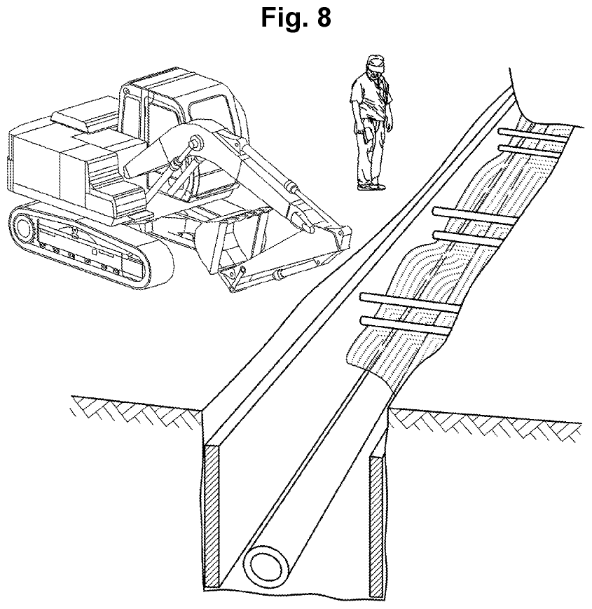

### DESCRIPTION OF EMBODIMENTS

Embodiments to implement the present invention will be described in detail below with reference to the drawings. Note that the same constituents are basically denoted by the same reference numbers, and repetitive description is omitted. In each figure, the ratios of the longitudinal dimensions and lateral dimensions of each constituent are exaggerated compared to the actual ratios for convenience of explanation.

In the following description, the term “vertical” means the direction parallel with the Z axis of the coordinate axis indication illustrated in drawings, the term “upper” means the plus direction of the Z axis, and the term “lower” means the minus direction of the Z axis. The term “horizontal” means directions parallel with the XY plane of the coordinate axis indication illustrated in drawings. However, the terms “upper” and “lower” are determined merely for convenience, and hence, they should not be interpreted in limited ways.

### First Embodiment

<Measurement Device>

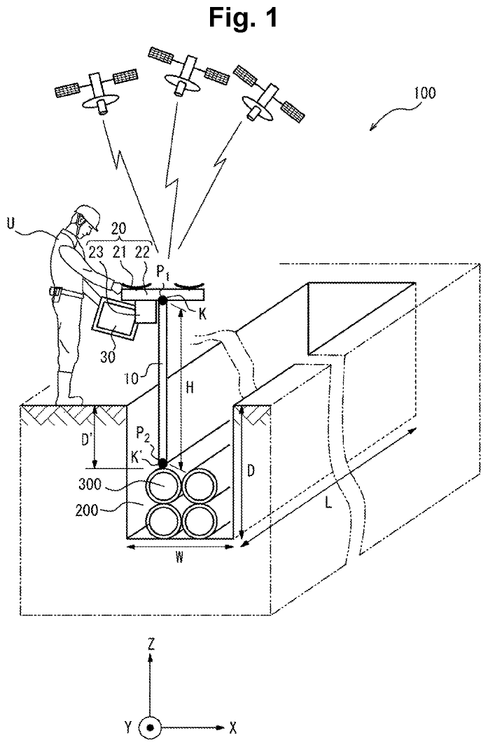

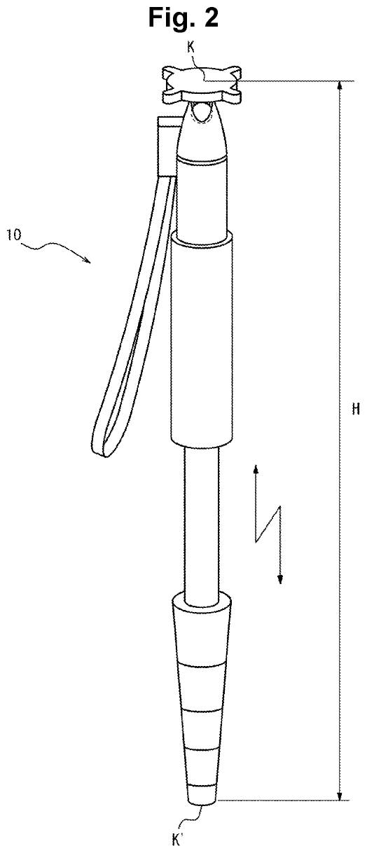

An example of the configuration of a measurement device 100 according to a first embodiment will be described with reference to FIGS. 1 and 2.

The measurement device 100 is a device that measures the absolute coordinates (for example, east longitude: x° E, north latitude: x° N, altitude: x° H, and the like) of a target object 300 provided inside an excavation ditch 200. The excavation ditch 200, for example, has an excavation depth of D, an excavation width of W, and an excavation length of L. The target object 300 is, for example, a pipeline, which is provided at a place where it is difficult for the operator U to come close, specifically, at a place overburden depth D′ away from the ground surface. For this reason, the operator U uses the measurement device 100 to measure the absolute coordinates of the target object 300.

The measurement device 100 includes a distance measurement unit 10, a coordinate measurement unit 20, and a calculation unit 30. The calculation unit 30 includes a control unit, a storage unit, an input unit, and an output unit.

The distance measurement unit 10 has an upper end portion K (for example, a reference point) which is placed right above the target object 300 in the vertical direction, and measures the vertical distance H between the upper end portion K and the target object 300. The distance measurement unit 10 is, for example, a measurement rod.

FIG. 2 illustrates, as an example of a distance measurement unit 10, an extension rod (measurement rod) having an extension mechanism. The operator U adjusts the upper end portion K of the extension rod 10 to a position right above the target object 300 in the vertical direction and then extends or contracts the extension rod 10 to adjust the length of the extension rod 10 as appropriate such that the lower end portion K′ of the extension rod 10 is in contact with the target object 300. Then, the operator U obtains the distance between the upper end portion K and lower end portion K′ of the extension rod 10, in other words, the length of the extension rod 10, as the vertical distance H between the upper end portion K of the extension rod 10 and the target object 300. Then, the operator U uses the input unit included in the calculation unit 30 to input measurement data indicating the vertical distance H into the calculation unit 30.

The extension rod 10 should preferably have an extension range of approximately 1.5 m to approximately 2.5 m. This configuration enables the operator U to conduct measurement according to the excavation depth D, the excavation width W, and the excavation length L. In addition, the extension rod 10 should preferably have a thick proximal portion which the operator U holds. This configuration enables the operator U to conduct stable measurement.

The extension rod 10 may have a configuration in which it can extend to have any length or a configuration in which it can extend stepwise to have lengths set in advance (for example, 50 cm, 80 cm, 100 cm, and the like).

The coordinate measurement unit 20 uses a satellite positioning system that determines the current position on the ground by utilizing a plurality of satellites to measure the position coordinates (absolute coordinates) P₁(X, Y, Z) of the upper end portion K of the distance measurement unit 10. A GNSS is a generic name of satellite positioning systems including the GPS (the USA), the Quasi-Zenith Satellite System, the GLONASS (Russia), and the GALILEO (under planning by EU). The coordinate measurement unit 20 includes a GNSS antenna 21, a GNSS receiver 22, and a GNSS module 23. Note that the position coordinates P₁(X, Y, Z) of the upper end portion K of the distance measurement unit 10 agrees with the position coordinates of the reference point mentioned above.

The GNSS antenna 21 is attached to an appropriate position on the GNSS receiver 22 to face the zenith direction, by using a connection mechanism 41 or a connection mechanism 42 so that it can capture radio waves from a plurality of satellites.

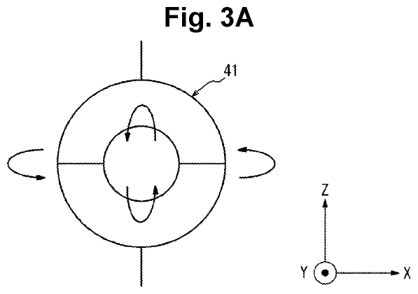

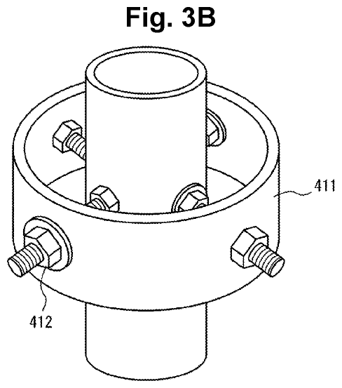

For example, as illustrated in FIGS. 3A and 3B, the connection mechanism 41 may be a two-axis mechanism that can rotate on the X axis or the Y axis and also rotate on the Z axis. The connection mechanism 41 includes, for example, a frame 411, ball bearing units 412, and a weight. The weight is disposed inside the frame 411. Use of the connection mechanism 41 makes it possible to adjust the GNSS antenna 21 with smooth movement such that the GNSS antenna 21 can face the zenith direction.

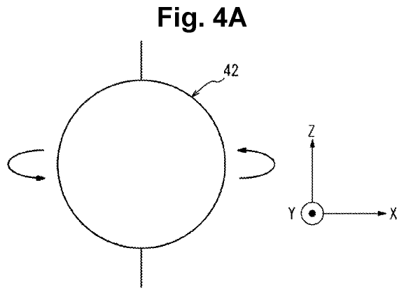

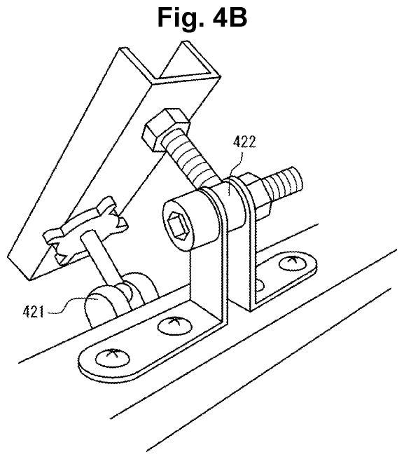

For example, as illustrated in FIGS. 4A and 4B, the connection mechanism 42 may be a one-axis mechanism that can rotate on the Z axis. The connection mechanism 42 includes, for example, a frame 421, a ball bearing unit 422, and a weight. The weight is disposed inside the frame 421. The connection mechanism 42 has one fixed axis, so that the connection mechanism 42 is more stable than the connection mechanism 41. Hence, it is preferable that the operator U use the connection mechanism 42 in an environment in which his/her hands are not stable, such as when strong winds blow. Use of the connection mechanism 42 improves the stability of the GNSS antenna 21.

Since the connection mechanisms 41 and 42 have weights at their lower portions, they are pulled by the weights vertically downward. With this configuration, the GNSS antenna 21 is suspended from the GNSS receiver 22 by using the connection mechanism 41 or 42, and this enables the GNSS antenna 21 to be horizontal no matter how the operator U tilts the distance measurement unit 10. This enables the GNSS antenna 21 to capture radio waves from more satellites, enabling the coordinate measurement unit 20 to efficiently receive radio waves from a plurality of satellites and conduct highly accurate measurement. Note that the connection mechanism 41 or 42 may be selected as appropriate depending on the use, environment, and the like so as to take its advantages.

In addition, use of the connection mechanism 41 or 42 as above for attaching the GNSS antenna 21 to the GNSS receiver 22 can reduce the operator U's efforts and shorten the time for the attachment, compared to the case in which the operator U attaches the GNSS antenna 21 to the GNSS receiver 22 using a tripod and a level in the conventional way.

The GNSS receiver 22 receives radio waves from a plurality of satellites via the GNSS antenna 21. The GNSS receiver 22 is disposed at the upper end portion K of the distance measurement unit 10. The GNSS receiver 22 is connected to the GNSS antenna 21 by using the connection mechanism 41 or 42.

The GNSS module 23 calculates the position coordinates P₁(X, Y, Z) of the upper end portion K of the distance measurement unit 10, based on the radio waves received by the GNSS receiver 22. Then, the GNSS module 23 outputs, to the calculation unit 30, measurement data indicating the position coordinates P₁(X, Y, Z) of the upper end portion K of the distance measurement unit 10.

The calculation unit 30 is, for example, a mobile phone such as a smartphone, a tablet terminal, a laptop PC (personal computer), or the like used by the operator U. The control unit may be composed of dedicated hardware, or may be composed of a general-purpose processor or a processor dedicated to specific processes. The storage unit includes at least one memory, and it may, for example, include a semiconductor memory, a magnetic memory, an optical memory, or the like. Each memory included in the storage unit may, for example, function as a main storage device, an auxiliary storage device, or a cache memory. The input unit may be any device that allows the operator U to perform specified operations, and is, for example, a microphone, a touch panel, a keyboard, a mouse, or the like. The output unit is, for example, a liquid crystal display, an organic electro-luminescence (EL) display, a speaker, or the like.

The calculation unit 30 calculates the absolute coordinates P₂(X, Y, Z−H) of the target object 300, based on the vertical distance H between the upper end portion K of the distance measurement unit 10 and the target object 300 and the position coordinates P₁(X, Y, Z) of the upper end portion K of the distance measurement unit 10. Measurement data indicating the vertical distance H between the upper end portion K of the distance measurement unit 10 and the target object 300, calculation data indicating the position coordinates P₁(X, Y, Z) of the upper end portion K of the distance measurement unit 10, calculation data indicating the absolute coordinates P₂(X, Y, Z−H) of the target object 300, and the like are stored in the storage unit included in the calculation unit 30.

The calculation unit 30 calculates the absolute coordinates of the entire target object 300, based on the position coordinates of a plurality of points calculated for specified measurement points on the target object 300 (for example, the positions of changes in the pipeline alignment). The absolute coordinates of the entire target object 300 are, for example, displayed in the display included in the calculation unit 30, and this allows the operator U to know the absolute coordinates of the entire target object 300.

The measurement device 100 according to the first embodiment measures the vertical distance H between the upper end portion K of the distance measurement unit 10 and the target object 300 and the position coordinates P₁(X, Y, Z) of the upper end portion K of the distance measurement unit 10, and based on these, calculates the absolute coordinates P₂(X, Y, Z−H) of the target object 300. This makes it possible to efficiently measure the absolute coordinates P₂(X, Y, Z−H) of the target object 300 provided inside the excavation ditch 200. Since in the measurement device 100 according to the first embodiment, the measurement rod itself serves as the distance measurement meter, and accordingly, the operator U needs to come close to the excavation ditch 200 to a distance where the operator U conducts measurement safely, the measurement device 100 is useful, in particular, in the case in which the excavation width W of the excavation ditch 200 is narrow.

Since the measurement device 100 according to the first embodiment does not require equipment such as a tripod and a level, it is possible to reduce the time to set up the device compared to conventional ones. In addition, in case of measuring a plurality of measurement points, it is not necessary to set up equipment again unlike conventional techniques, thus it is possible to improve work efficiency. In addition, since the number of parts is small, it is also possible to reduce the weight for transportation. In addition, it does not require post-processes such as stereo camera analysis after measurement unlike conventional techniques. In addition, since the volume of the extension rod and other articles is smaller than the articles of conventional techniques, this improves the portability of the measurement device 100 and makes it easy to set up the measurement device 100. In addition, since the GNSS antenna 21 is provided to face the zenith direction, it is possible to maximize the number of satellites that can be captured.

<Measurement Method>

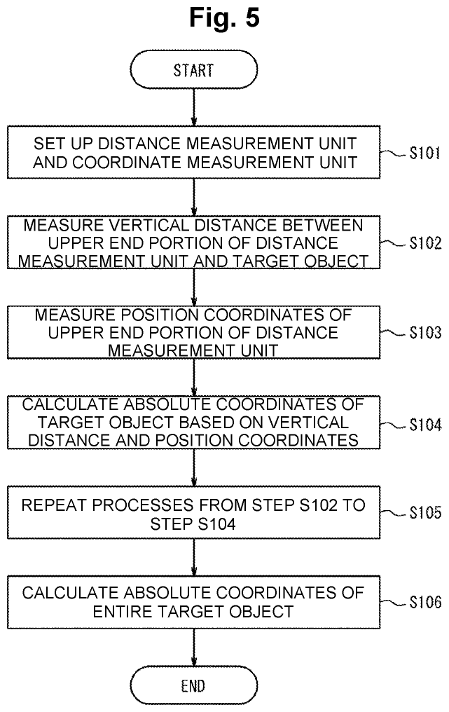

Next, a measurement method according to the first embodiment will be described with reference to FIG. 5.

Step S101: The operator U sets up the distance measurement unit 10 and the coordinate measurement unit 20.

Step S102: The measurement device 100 measures the vertical distance H between the upper end portion K of the distance measurement unit 10 and the target object 300.

Step S103: The measurement device 100 measures the position coordinates P₁(X, Y, Z) of the upper end portion K of the distance measurement unit 10.

Step S104: The measurement device 100 calculates the absolute coordinates P₂(X, Y, Z−H) of the target object 300, based on the vertical distance H between the upper end portion K of the distance measurement unit 10 and the target object 300 and the position coordinates P₁(X, Y, Z) of the upper end portion K of the distance measurement unit 10.

Step S105: The measurement device 100 repeats the processes from the above step S102 to step S104 for each of specified measurement points (for example, the positions of changes in the pipeline alignment) of the target object 300.

Step S106: The measurement device 100 calculates the absolute coordinates of the entire target object 300.

The above measurement method makes it possible to efficiently measure the absolute coordinates P₂(X, Y, Z−H) of the target object 300 provided inside the excavation ditch 200. Since the above measurement method shortens the preparation time until measurement and enables efficient transportation of the measurement device 100, it is useful, in particular, in the case of measuring a plurality of measurement points.

### Second Embodiment

<Measurement Device>

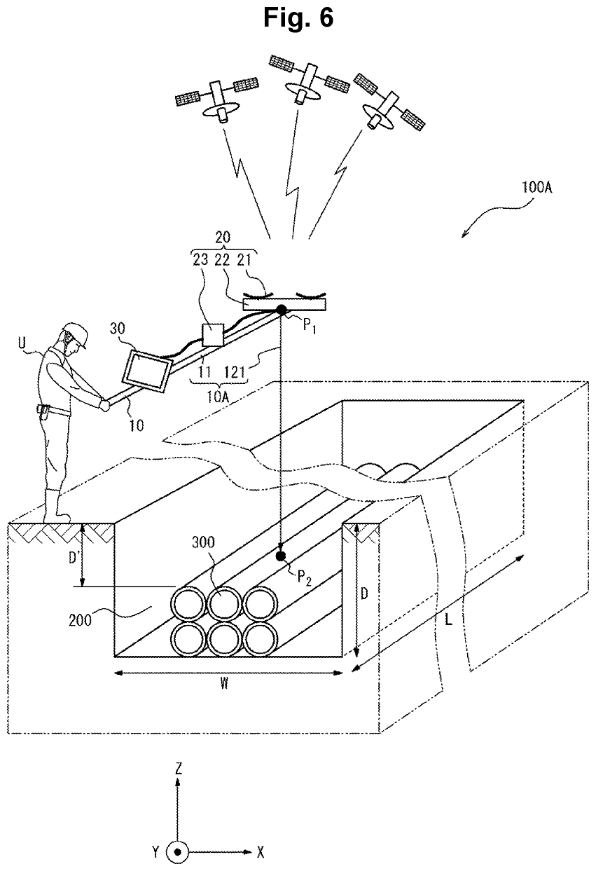

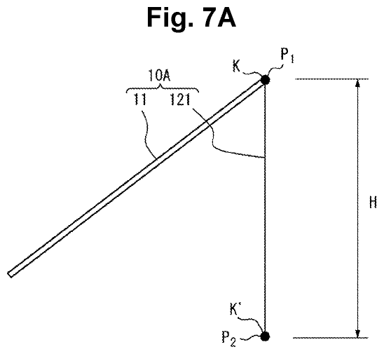

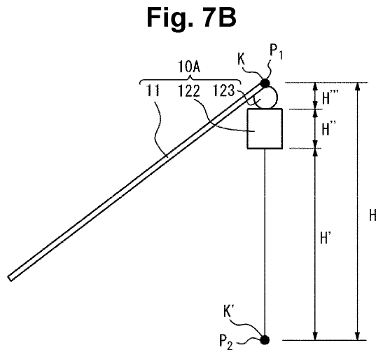

An example of the configuration of a measurement device 100A according to a second embodiment will be described with reference to FIGS. 6 and 7.

The measurement device 100A according to the second embodiment is different from the measurement device 100 according to the first embodiment in that although the distance measurement unit 10 of the measurement device 100 according to the first embodiment includes the measurement rod, a distance measurement unit 10A of the measurement device 100A according to the second embodiment includes a string or a distance measurement meter in addition to the measurement rod. Since the other constituents are the same as those in the measurement device 100 according to the first embodiment, repetitive description thereof is omitted.

The distance measurement unit 10A has an upper end portion K which is placed right above the target object 300 in the vertical direction, and measures the vertical distance H between the upper end portion K and the target object 300.

As illustrated in FIG. 7A, the distance measurement unit 10A may have a configuration including a measurement rod 11 and a string 121. The measurement rod 11 should preferably be, for example, an extension rod that can extend and contract, and the measurement rod 11 should preferably be a mechanism that can extend or contract according to the excavation width W of the excavation ditch 200. The configuration of the string 121 is not limited to any specific ones as long as the string 121 has a fixed length. For example, the string is formed of cloth, leather, or the like. For example, in the case in which the target object 300 is a communication pipeline, since communication pipelines are buried at a depth approximately 1.0 m to approximately 1.8 m from the ground surface in many cases, the string 121 should preferably have a fixed length of approximately 2.5 m in consideration of the position of the arm of the operator U having an average height.

In the case in which the excavation width W of the excavation ditch 200 is large, the operator U adjusts the upper end portion K of the measurement rod 11 to a position right above the target object 300 in the vertical direction, and then the operator U places the string 121 such that the lower end portion K′ of the string 121 is in contact with the target object 300. Then, the operator U obtains the length of the string 121 as the vertical distance H between the upper end portion K of the distance measurement unit 10A and the target object 300. Then, the operator U inputs measurement data indicating the vertical distance H between the upper end portion K of the distance measurement unit 10A and the target object 300, into the calculation unit 30 by using the input unit included in the calculation unit 30. Then, the operator U obtains the absolute coordinates P₂(X, Y, Z−H) of the target object 300 from the calculation unit 30.

As illustrated in FIG. 7B, the distance measurement unit 10A may have a configuration including a measurement rod 11, a distance measurement meter 122, and a suspension metal part 123. The measurement rod 11 should preferably be, for example, an extension rod that can extend and contract, and the measurement rod 11 should preferably be a mechanism that can extend or contract according to the excavation width W of the excavation ditch 200. The distance measurement meter 122 may be, for example, a laser distance measurement meter. The distance measurement meter 122 is suspended from the measurement rod 11 via the suspension metal part 123.

In the case in which the excavation width W of the excavation ditch 200 is large, the operator U adjusts the upper end portion K of the measurement rod 11 to a position right above the target object 300 in the vertical direction, and then the operator U measures the vertical distance H′ between the lower end portion of the distance measurement meter 122 and the target object 300 by using the distance measurement meter 122. Then, the operator U obtains the sum of the vertical distance H′ between the lower end portion of the distance measurement meter 122 and the target object 300, the length H″ of the distance measurement meter 122, and the length H′″ of the suspension metal part 123, as the vertical distance H between the upper end portion K of the distance measurement unit 10A and the target object 300. Then, the operator U inputs measurement data indicating the vertical distance H into the calculation unit 30, by using the input unit included in the calculation unit 30. Then, the operator U obtain the absolute coordinates P₂(X, Y, Z−H) of the target object 300 from the calculation unit 30.

The measurement device 100A according to the second embodiment measures the vertical distance H between the upper end portion K of the distance measurement unit 10A and the target object 300, and the position coordinates P₁(X, Y, Z) of the upper end portion K of the distance measurement unit 10A. Based on these, the measurement device 100A calculates the absolute coordinates P₂(X, Y, Z−H) of the target object 300. This makes it possible to efficiently measure the absolute coordinates P₂(X, Y, Z−H) of the target object 300 provided inside the excavation ditch 200.

Since the distance measurement unit 10A in the measurement device 100A according to the second embodiment includes the string or the distance measurement meter in addition to the measurement rod, it eliminates the need for a tape measure or the like, making it possible to conduct appropriate measurement by using the measurement rod 11 from a side of the excavation ditch 200, according to the excavation widths W of the various excavation ditches 200 that differ depending on the construction scale. Application of the measurement device 100A according to the second embodiment enables the operator U to obtain the absolute coordinates P₂(X, Y, Z−H) of the target object 300 by inclining the measurement rod 11 of the distance measurement unit 10A according to the excavation width W of the excavation ditch 200, making it possible to conduct safe measurement without coming close to the excavation ditch 200. Hence, the measurement device 100A according to the second embodiment is useful, in particular, in the case in which the excavation width W of the excavation ditch 200 is large.

Although the above embodiments have been described as representative examples, it is obvious to those skilled in the art that various kinds of change and replacement are possible within the spirit and the scope of the present disclosure. Hence, it should not be interpreted that the present invention is limited by the above embodiments, and various modifications and changes are possible without departing from the scope of the claims. For example, a plurality of configuration blocks described in the configuration diagram of the embodiments can be combined into one block, or one configuration block can be divided. A plurality of processes shown in the flowchart of the embodiments can be combined into one process, or one process can be divided.

### REFERENCE SIGNS LIST

10, 10A Distance measurement unit
11 Measurement rod
20 Coordinate measurement unit
21 GNSS antenna
22 GNSS receiver
23 GNSS module
30 Calculation unit
41 Connection mechanism
42 Connection mechanism
100, 100A Measurement device
121 String
122 Distance measurement meter
123 Suspension metal part
200 Excavation ditch
300 Target object
411 Frame
412 Ball bearing unit
421 Frame
422 Ball bearing unit

1. A device for measuring an absolute coordinate of a target object provided inside an excavation ditch, the device comprising a processor configured to execute a method comprising:
measuring a position coordinate of a reference point in a vertical direction from the target object;
measuring the vertical distance from the reference point to the target object; and
calculating the absolute coordinate of the target object based on the vertical distance and the position coordinate.

2. The device according to claim 1, wherein the measuring the position coordinate further includes:
receiving, using an antenna facing the zenith direction, radio waves at the reference point, wherein the antenna is associated with a global navigation satellite.

3. The device according to claim 1, wherein
the measuring the vertical distance further includes using an extension mechanism.

4. The measurement device according to claim 1,
wherein the measuring the vertical distance uses a string having a fixed length,
wherein the string includes one end connected to the reference point, and
wherein the measuring the vertical distance further includes obtaining the fixed length of the string as the vertical distance when the string is placed such that the other end of the string is in contact with the target object.

5. The device according to claim 1, wherein
the measuring the position coordinate further includes measuring the vertical distance to the target object using a distance measurement meter connected to the reference point.

6. A computer implemented method for measuring an absolute coordinate of a target object provided inside an excavation ditch, the method comprising:
measuring a position coordinate of a reference point in a vertical direction from the target object;
measuring the vertical distance from the reference point to the target object; and
calculating the absolute coordinate of the target object based on the vertical distance and the position coordinate.

7. The device according to claim 2, wherein
the measuring the vertical distance further includes using an extension mechanism.

8. The device according to claim 2,
wherein the measuring the vertical distance further includes using a string having a fixed length,
wherein the string includes one end connected to the reference point, and
wherein the measuring the vertical distance further includes obtaining the fixed length of the string as the vertical distance when the string is placed such that the other end of the string is in contact with the target object.

9. The device according to claim 2, wherein
the measuring the position coordinate further includes measuring the vertical distance to the target object using a distance measurement meter connected to the reference point.

10. The device according to claim 3,
wherein the measuring the vertical distance further includes using a string having a fixed length,
wherein the string includes one end connected to the reference point, and
wherein the measuring the vertical distance further includes obtaining the fixed length of the string as the vertical distance when the string is placed such that the other end of the string is in contact with the target object.

11. The device according to claim 3, wherein
the measuring the position coordinate further includes measuring the vertical distance to the target object using a distance measurement meter connected to the reference point.

12. The computer implemented method according to claim 6, wherein the measuring the position coordinate further includes:
receiving, using an antenna facing the zenith direction, radio waves at the reference point, wherein the antenna is associated with a global navigation satellite.

13. The computer implemented method according to claim 6, wherein
the measuring the vertical distance further includes using an extension mechanism.

14. The computer implemented method according to claim 6,
wherein the measuring the vertical distance further includes using a string having a fixed length,
wherein the string includes one end connected to the reference point, and
wherein the measuring the vertical distance further includes obtaining the fixed length of the string as the vertical distance when the string is placed such that the other end of the string is in contact with the target object.

15. The computer implemented method according to claim 6, wherein
the measuring the position coordinate further includes measuring the vertical distance to the target object using a distance measurement meter connected to the reference point.

16. The computer implemented method according to claim 12, wherein
the measuring the vertical distance further includes using an extension mechanism.

17. The computer implemented method according to claim 12,
wherein the measuring the vertical distance further includes using a string having a fixed length,
wherein the string includes one end connected to the reference point, and
wherein the measuring the vertical distance further includes obtaining the fixed length of the string as the vertical distance when the string is placed such that the other end of the string is in contact with the target object.

18. The computer implemented method according to claim 12, wherein
the measuring the position coordinate further includes measuring the vertical distance to the target object using a distance measurement meter connected to the reference point.

19. The computer implemented method according to claim 13,
wherein the measuring the vertical distance further includes using a string having a fixed length,
wherein the string includes one end connected to the reference point, and
wherein the measuring the vertical distance further includes obtaining the fixed length of the string as the vertical distance when the string is placed such that the other end of the string is in contact with the target object.

20. The computer implemented method according to claim 13, wherein
the measuring the position coordinate further includes measuring the vertical distance to the target object using a distance measurement meter connected to the reference point.
